(19) United States
(12) Patent Application Publication
(10) Pub. No.: US 2006/0261186 A1
(43) Pub. Date: Nov. 23, 2006

(54) Hand-portable pressurized sprayer apparatus provided with safety valve

(76) Inventors: James R. Fontaine, Marilla, NY (US); James W. Campbell, Akron, NY (US)

Correspondence Address: Kenneth J. LuKacher;South Winton Court, Suite 301, 3136 Winton Road South, Rochester, NY, 14623, US

(21) Appl. No.: 11/373,389

(22) Filed: Mar. 10, 2006

Related U.S. Application Data
(60) Provisional application No. 60/662,268, filed on Mar. 16, 2005.

(51) Int. Cl. A62C 13/62; F23D 14/28; B05B 1/30; A62C 13/66

(52) U.S. Cl. 239/302; 239/337; 239/569

(57) ABSTRACT

An improved hand-portable pressurized sprayer apparatus of the present invention has a valve assembly that is sealably connected to a fluid supply tank and includes a safety valve constructed to respond to the occurrence of a predetermined maximum pressure value within the spray tank. The occurrence of pressure within the tank that exceeds the predetermined maximum value causes the safety valve to open, thereby allowing the release of excess tank pressure. The sprayer apparatus provides for the controlled pressurization of the supply tank using an external compressed air supply.

Priority is claimed to U.S. Provisional Application Ser. No. 60/662,268, filed Mar. 16, 2005, which is herein incorporated by reference.

### FIELD OF THE INVENTION

The present invention is related to sprayer apparatus, more particularly, to a hand-portable pressurized sprayer apparatus provided with a safety valve, and to a method for controlling the pressurization of the sprayer supply tank using an external compressed air supply.

### BACKGROUND OF THE INVENTION

Pump sprayers are typically used for dispensing a wide variety of fluids such as, for example, insecticides, herbicides, degreasers, stains, paints, and concrete treating compositions. Conventional hand-portable pump sprayers include a fluid supply tank that typically also serves as a pressure vessel, a manual pump or piston, a bulkhead fitting on the supply tank, a tube extending from the interior end of the bulkhead fitting substantially to the bottom of the tank, and a hose connected at one end to the external end of the bulkhead fitting and at the other to a discharge control valve and nozzle, from which the fluid is discharged. A typical pump sprayer, which has been modified by inclusion of a T-type fitting at the discharge control valve to enable connection to a water supply under pressure, is shown in FIG. 1 of U.S. Pat. No. 6,695,228, the disclosure of which is incorporated herein by reference.

Initially, the tank is filled to a designated line with the fluid to be sprayed, the air above the fluid being at atmospheric pressure. Operation of the manual pump forces air into the tank and increases the pressure of the air therein. The compressed air exerts pressure on the fluid contained in the tank; operation of the discharge control valve allows the pressure within the tank to push the fluid out through the nozzle until the discharge valve is closed or the air pressure within the tank falls to atmospheric. At or before that equilibrium point, repressurization of the tank by operation of the manual pump is required to continue spraying.

A great variety of hand-portable pressurized sprayers are commercially available. Many are intended to dispense fluids that are predominantly water, for example, aqueous solutions of insecticides or herbicides. Other sprayers are designed to dispense more highly viscous fluids such as concrete treatment compositions, for example, mold release agents.

If a sprayer is employed to dispense a largely aqueous fluid such as a herbicide solution, a relatively low tank overpressure, as little as 5 psi above atmospheric, is sufficient to spray the fluid at a convenient flow rate. Spraying a highly viscous fluid such as a concrete mold release agent requires a considerably higher overpressure, typically about 50 psi, to achieve a convenient delivery rate. Since a manual pump is typically capable of adding only 25-28 psi to the tank internal pressure, spraying viscous materials requires frequent laborious and time-consuming operation of the manual pump to maintain an adequate tank overpressure.

As an alternative or supplement to the use of the manual pump of a hand-held sprayer, provision can be made to connect an external supply of compressed air from, for example, an air compressor. This would enable a sprayer used for dispensing a viscous fluid such as a concrete mold release composition to be pressurized to a tank pressure higher than that attainable by use of the manual pump, thereby extending the effective time for spraying the viscous composition before repressurization is required.

Air compressors typically are capable of delivering air at a pressure of about 120 psi, well above the safe limit for operation of a hand-portable sprayer. It would therefore be very desirable to pressurize the sprayer apparatus using an external source of compressed air, while limiting the internal pressure of the sprayer tank to a specified maximum “safe” pressure, on the order of 50-60 psi. Some commercially available sprayers intended for use with an external compressed air supply are provided with a pressure reducing or regulating device that is intended to limit the fill pressure employed to pressurize the tank. Failure of such a device, however, would allow the tank to be exposed to the full pressurization capability of the external compressed air supply, with potentially dangerous consequences.

It would be highly desirable to provide a sprayer apparatus with a device that would ensure that the pressure within the tank does not exceed a specified maximum “safe” limit and would, in the event of its malfunction, fail in an “open” position, thereby preventing a hazardous overpressurization of the tank. These benefits are realized in the sprayer apparatus of the present invention.

### SUMMARY OF THE INVENTION

An improved hand-portable pressurized sprayer apparatus of the present invention includes a walled fluid supply tank for containing a sprayable fluid, a first bulkhead fitting having an interior and an exterior end that is sealably connected to the tank and provides an opening in the wall of the tank, a tube extending from the interior end of the first bulkhead fitting substantially to the bottom of the tank, and a flexible hose for transporting the fluid that is connected at one end to the external end of the first bulkhead fitting and at the other to a discharge control valve and nozzle, from which the fluid is discharged. The improvement comprises a valve assembly sealably connected to the tank and comprising a safety valve constructed to respond to the occurrence of a predetermined maximum pressure value within the tank, wherein the occurrence of pressure within the tank exceeding the predetermined maximum value causes the safety valve to open, thereby allowing the release of excess tank pressure.

Also in accordance with the present invention is a method for controlling the pressurization of the sprayer apparatus using an external compressed air supply.

### BRIEF DESCRIPTION OF THE DRAWINGS

FIG. 1 depicts the valve assembly included in the sprayer apparatus of the present invention.

FIG. 2 depicts a partial view of a sprayer tank having the valve assembly installed on the bulkhead.

FIG. 3 is a cross-sectional view of the valve assembly.

### DETAILED DESCRIPTION OF THE INVENTION

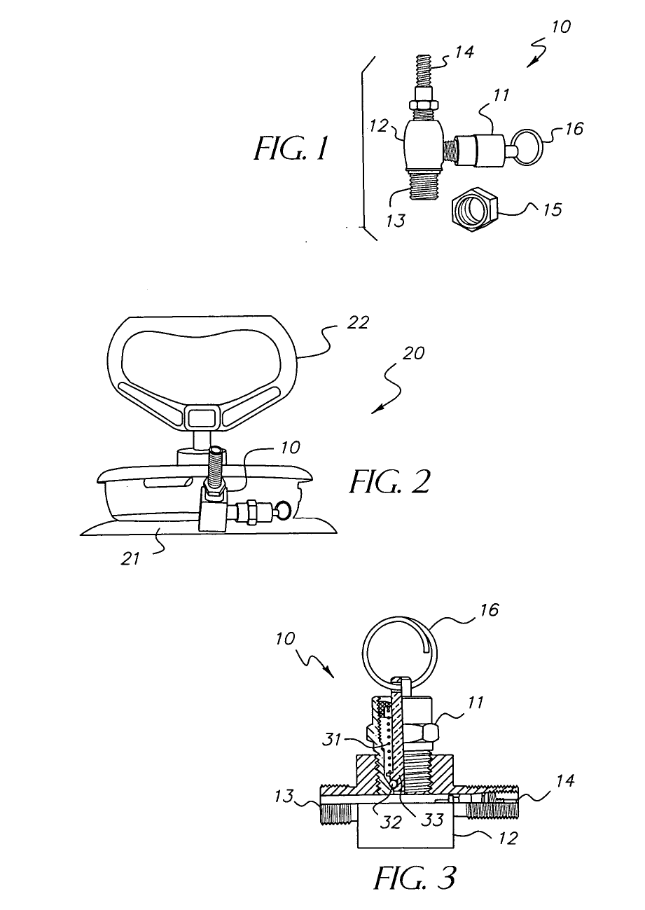

Referring to FIG. 1, a valve assembly 10 includes a safety valve 11 and a body 12 sealably connected to safety valve 11. A threaded nipple 13 for sealably connecting valve assembly 10 to a sprayer tank (not shown) and a threaded tire fill valve 14 for connecting valve assembly 10 to an external compressed air supply (not shown) are both sealably connected to body 12. Valve assembly 10 optionally includes a nut 15 for installation within the tank to secure valve assembly 10 to the tank wall. Safety valve 11 is provided with a pull ring 16 for manual operation. Body 12, threaded nipple 13, threaded tire fill valve 14, nut 15, and pull ring 16 are preferably formed from metal.

FIG. 2 is a partial view of a supply tank 20, depicting valve assembly 10 attached to the bulkhead 21 of tank 20, which preferably is formed from metal. Also shown in FIG. 2 is an optional manual pump 22 that can be used as an alternative to an external compressed air supply (not shown), which is the preferred means for pressurizing tank 20.

FIG. 3 is a cross-sectional view of valve assembly 10 showing safety valve 11, body 12, threaded nipple 13, threaded tire fill valve 14, and pull ring 16. Also depicted in FIG. 3, located within safety valve 11, are a compression spring 31, a ball 32, and a seat 33 for ball 32. Preferably, spring 31 and ball 32 are each formed from stainless steel, and ball seat 33 is formed from brass. In operation, when the pressure within the spray tank exceeds a predetermined maximum pressure value, preferably about 50 psi to about 60 psi, more preferably, about 55 psi, the resilient urge of compression spring 31 within safety valve 11 is overcome, causing safety valve 11 to open, thereby allowing the release of excess tank pressure.

The hand-portable pressurized sprayer apparatus of the present invention is especially useful for spraying highly viscous fluids such as, for example, a concrete mold release composition. Safety valves that can be employed as components of the valve assembly included in the sprayer apparatus are commercially available. One supplier of suitable safety valves is Control Devices, Incorporated, Saint Louis, Mo.

The invention has been described in detail with particular reference to certain preferred embodiments thereof, but it is understood that variations and modifications can be effected within the spirit and scope of the invention, which is defined by the claims that follow.

What is claimed is:

1. An improved hand-portable pressurized sprayer apparatus that includes: a walled fluid supply tank for containing a sprayable fluid; a first bulkhead fitting having an interior end and an exterior end, said first bulkhead fitting providing an opening in the wall of said tank; a tube extending from said interior end of said first bulkhead fitting substantially to the bottom of said tank, and a flexible hose for transporting said fluid, said hose being connected at one end to said external end of said bulkhead fitting and at the other to a discharge control valve and nozzle, through which said fluid is discharged;
the improvement comprising:
a valve assembly sealably connected to said tank and comprising a safety valve constructed to respond to the occurrence of a predetermined maximum pressure value within said tank, wherein the occurrence within said tank of pressure exceeding said predetermined maximum value causes said safety valve to open, thereby allowing the release of excess tank pressure.

2. The sprayer apparatus of claim 1 further comprising a manual pump sealably connected to said tank.

3. The sprayer apparatus of claim 1 wherein said valve assembly comprises a second bulkhead fitting.

4. The sprayer apparatus of claim 1 wherein said tank is formed from metal.

5. The sprayer apparatus of claim 1 wherein said valve assembly further comprises a body sealably connected to said safety valve, a threaded nipple for sealably connecting said valve assembly to said tank, and a threaded tire fill valve for connecting said valve assembly to an external compressed air supply, both said threaded nipple and said threaded tire fill valve being sealably connected to said body.

6. The sprayer apparatus of claim 5 wherein said body, said threaded nipple, and said threaded tire fill valve are each formed from metal.

7. The sprayer apparatus of claim 1 wherein said safety valve comprises a compression spring, a ball, and a seat for said ball.

8. The sprayer apparatus of claim 7 wherein said spring and said ball are each formed from stainless steel, and said seat is formed from brass.

9. The sprayer apparatus of claim 1 wherein said safety valve is constructed to open when pressure in said tank exceeds a predetermined maximum pressure value of about 50 psi to about 60 psi.

10. The sprayer apparatus of claim 9 wherein said safety valve is constructed to open when pressure in said tank exceeds a predetermined maximum pressure value of about 55 psi.

11. The sprayer apparatus of claim 1 wherein said sprayable fluid comprises a concrete mold release composition.

12. A method for controlling the pressurization of a hand-portable sprayer apparatus using an external compressed air supply, said method comprising:
providing a hand-portable sprayer apparatus that includes: a walled fluid supply tank for containing a sprayable fluid; a first bulkhead fitting having an interior end and an exterior end, said first bulkhead fitting providing an opening in the wall of said tank; a tube extending from said interior end of said first bulkhead fitting substantially to the bottom of said tank; a flexible hose for transporting said fluid, said hose being connected at one end to said external end of said bulkhead fitting and at the other to a discharge control valve and nozzle, through which said fluid is discharged; and a valve assembly sealably connected to said tank and comprising a safety valve constructed to respond to the occurrence of a predetermined maximum pressure value within the spray tank;
connecting said tank to said external compressed air supply; and
pressurizing said tank to a pressure up to and including said predetermined maximum pressure value;
wherein, in the event of the occurrence of pressure within said tank exceeding said predetermined maximum pressure value, said safety valve opens, thereby allowing the release of excess tank pressure.

13. The method claim 12 wherein said external compressed air supply comprises an air compressor.

14. The method of claim 12 wherein said sprayer apparatus further includes a manual pump sealably connected to said tank.

15. The method of claim 12 wherein said valve assembly sealably connected to said tank comprises a second bulkhead fitting, and further comprises a body sealably connected to said safety valve, a threaded nipple for sealably connecting said valve assembly to said tank, and a threaded tire fill valve for connecting said valve assembly to said external compressed air supply, both said threaded nipple and said threaded tire fill valve being sealably connected to said body.

16. The method of claim 12 wherein said tank, said body, said threaded nipple, and said threaded tire fill valve are each formed from metal.

17. The method of claim 12 wherein said safety valve comprises a compression spring, a ball, and a seat for said ball, and wherein said spring and said ball are each formed from stainless steel, and said seat is formed from brass.

18. The method of claim 12 wherein said safety valve is constructed to open when pressure in said tank exceeds a predetermined maximum pressure value of about 50 psi to about 60 psi.

19. The method of claim 18 wherein said safety valve is constructed to open when pressure in said tank exceeds a predetermined maximum pressure value of about 55 psi.

20. The method of claim 12 wherein said sprayable fluid comprises a concrete mold release composition.

21. A valve assembly for a sprayer comprising in a unitary structure a fill valve for filling the sprayer with material under compressed air pressure, a safety valve responsive to over pressure of said air and a nipple connectable to said chamber all in fluid communicating relationship with each other.

22. The valve of claim 21 wherein said nipple, said fill valve and said safety valve are in separate arms of a T provided by said unitary structure.
